(19) United States
(12) Patent Application Publication
(10) Pub. No.: US 2026/0097930 A1
(43) Pub. Date: Apr. 9, 2026

(54) CONVEYANCE SYSTEM WITH MOVING SUPPORT SURFACES

(71) Applicant: Beltways Inc., Cincinnati, OH (US)

(72) Inventors: Matine Yuksel, Cincinnati, OH (US); Yahya John Yuksel, Cincinnati, OH (US); Edip Yuksel, Cincinnati, OH (US)

(21) Appl. No.: 19/350,972

(22) Filed: Oct. 6, 2025

Related U.S. Application Data
(60) Provisional application No. 63/703,250, filed on Oct. 4, 2024.

(51) Int. Cl. B66B 23/24

(52) U.S. Cl. CPC B66B 23/24

(57) ABSTRACT

A flat handrest system that includes a belt engageable by passengers using a conveyance system. The flat handrest system also includes a propulsion system for propelling the belt around a belt loop. The flat handrest system is positioned within an opening of a side housing of a conveyance system, the opening defines an area where the belt can be engaged by the passengers. A flat handrest system that includes a belt engageable by passengers using a conveyance system. The flat handrest system also includes a propulsion system for propelling the belt around a belt loop. The belt of the flat handrest system is non-graspable by passengers. A conveyance system having a moving treadway and at least one side housing disposed adjacent to the moving treadway. The conveyance system can also include the flat handrest system described herein.

### STATEMENT REGARDING DERDERALLY SPONSORED RESEARCH OR DEVELOPEMENT

Not applicable.

### CROSS-REFERENCE TO RELATED APPLICATIONS

The present application is a conversion of U.S. Provisional Application having U.S. Serial No. 63/703,250, filed October 04, 2024, which claims the benefit under 35 U.S.C. 119(e). The disclosure of which is hereby expressly incorporated herein by reference.

### BACKGROUND OF THE DISCLOSURE

### 1. Field of the Invention

The present disclosure relates to a flat handrest system for use with a people mover, such as moving walkways.

### 2. Description of the Related Art

Typically, moving walkways have a handrail that is meant to be grasped by individuals riding the moving walkway. To achieve this the handrail has to extend upward from a side housing of the moving walkway and this exposes the riders of the moving walkways to the sides of the handrails, which are moving and can cause certain issues. Individuals who might be walking, standing, or sitting adjacent to the handrails also have to worry about the sides of the moving handrails, which could potentially cause various issues.

Accordingly, there is a need for a handrest system where the sides of the handrests are not capable of being engaged with by riders of the moving walkways or people adjacent to the moving walkways.

### SUMMARY OF THE DISCLOSURE

The present disclosure is directed to a flat handrest system that includes a belt engageable by passengers using a conveyance system. The flat handrest system also includes a propulsion system for propelling the belt around a belt loop. The flat handrest system is positioned within an opening of a side housing of a conveyance system, the opening defines an area where the belt can be engaged by the passengers. In an alternative, the belt of the flat handrest system is non-graspable by the passengers.

The present disclosure is also directed to a conveyance system having a moving treadway and at least one side housing disposed adjacent to the moving treadway. The conveyance system can also include the flat handrest system described herein.

### BRIEF DESCRIPTION OF THE DRAWINGS

FIG. 1 is a perspective view of a moving walkway incorporating a moving handrest system constructed in accordance with the present disclosure.

FIG. 2 is a perspective, close-up view of the moving walkway and the moving handrest system constructed in accordance with the present disclosure.

FIGS. 3A and 3B are close-up, perspective views of the moving handrest system constructed in accordance with the present disclosure.

FIGS. 4A and 4B are perspective views of the moving handrest system constructed in accordance with the present disclosure.

FIG. 5 is a side elevation view of parts of two moving handrest systems constructed in accordance with the present disclosure.

FIG. 6 is a side elevation view of one embodiment of the moving walkway and the moving handrest system constructed in accordance with the present disclosure.

FIG. 7 is a perspective view of another embodiment of the moving walkway and the moving handrest system constructed in accordance with the present disclosure.

FIG. 8 is a close-up, perspective view of a portion of the moving handrest system constructed in accordance with the present disclosure.

FIGS. 9A and 9B are views of another embodiment of the moving walkway constructed in accordance with the present disclosure.

FIG. 10 is a side elevation view of an alternative embodiment of the moving walkway shown in FIGS. 9A and 9B and constructed in accordance with the present disclosure.

FIG. 11 is a side elevation view of another alternative embodiment of the moving walkway shown in FIGS. 9A and 9B and constructed in accordance with the present disclosure.

FIGS. 12A and 12B are views of yet another embodiment of the moving walkway constructed in accordance with the present disclosure.

FIG. 13 is a side elevation view of an alternative embodiment of the moving walkway shown in FIGS. 12A and 12B and constructed in accordance with the present disclosure.

FIG. 14 is a side elevation view of another alternative embodiment of the moving walkway shown in FIGS. 12A and 12B and constructed in accordance with the present disclosure.

### DETAILED DESCRIPTION OF THE DISCLOSURE

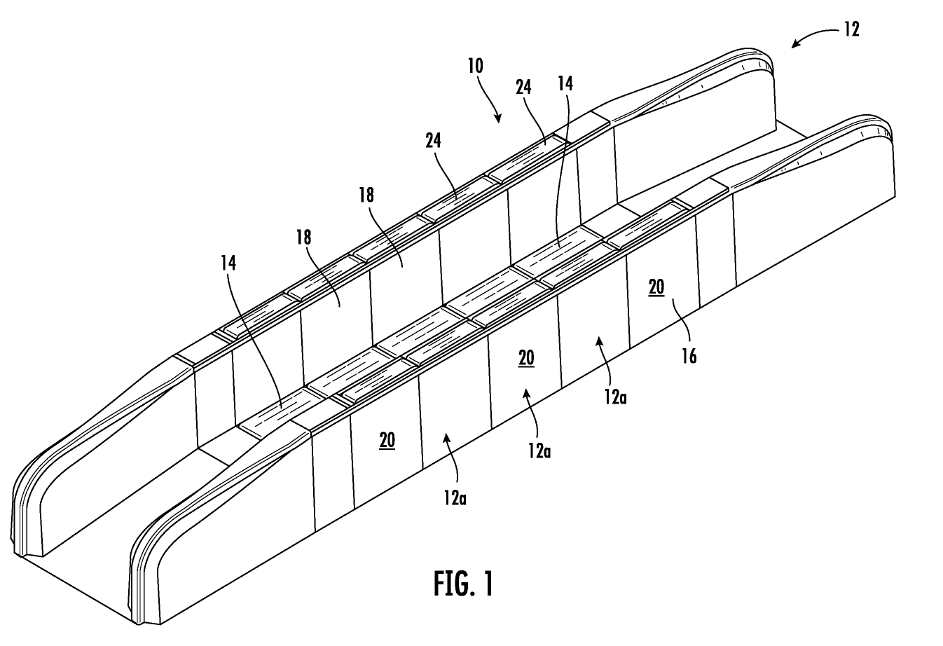

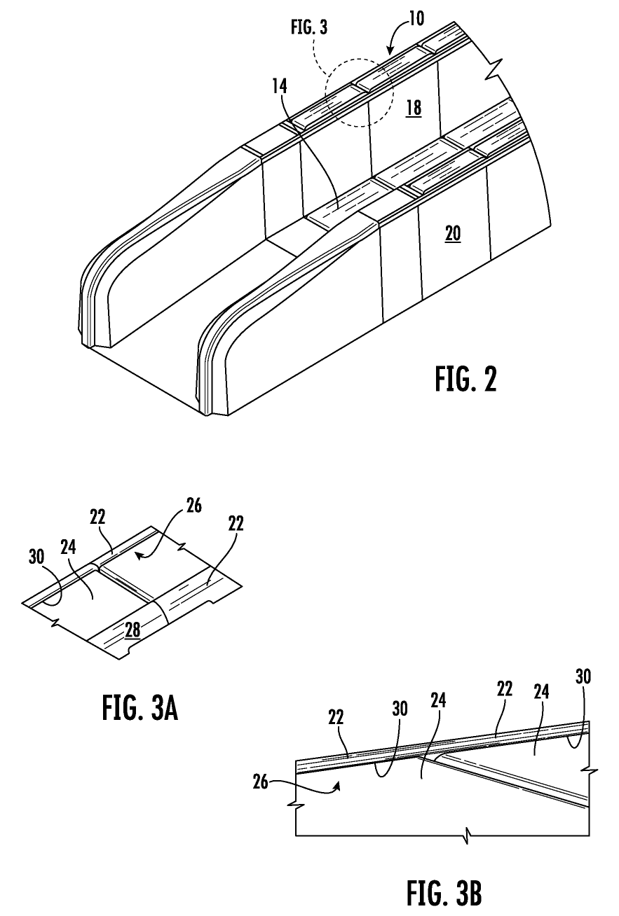

Referring now to FIGS. 1 and 2, the present disclosure relates to a flat handrest system 10 used with moving walkways 12. The moving walkways 12 could be modular moving walkways, accelerating moving walkways, or any other type of people mover known in the art. The flat handrest system 10 provide passenger stability and can provide passengers a platform to rest their bags and other objects on while riding. In one embodiment, the flat handrest system 10 could be positioned at a height and have a width where a passenger could use the belt as a seat. The moving walkway can include a moving treadway 14 and at least one side housing 16 (balustrade) for encapsulating operational and support components of the moving walkway 12 and/or the flat handrest system 10. Depending upon the orientation of the moving walkway 12 there could be a flat handrest system 10 on one or both sides of the moving walkway 12. Furthermore, if the moving walkway 12 is made up of moving walkway modules 12a each moving walkway module 12a could have its own flat handrest system 10a. Each side housing 16 can include an inner housing member 18, an outer housing member 20, and an upper housing member 22. In a typical moving walkway 12, the treadway 14 can extend between (and potentially under) opposing inner housing members 18 of two side housings 16 and a flat handrest system 10 can be supported by each side housing 16.

The flat handrest system 10 can be installed such that at least a portion of a belt 24 of the flat handrest system 10 is exposed in an opening 26 in a top side 28 of the upper housing member 22 of the side housing 16. The flat handrest system 10 is unique in that the belt 24 is not graspable by a passenger riding the moving walkway 12. In one embodiment shown in FIGS. 3A and 3B, the engageable, or exposed, part of the belt 24 can be below the top side 28 of the upper housing member 22. In another embodiment, the flat handrest system 10 can be set up such that the engageable part of the belt 24 is generally flush with the top side 28 of the upper housing member 22. In yet another embodiment, the flat handrest system 10 can be set up such that the engageable part of the belt 24 is positioned just above the top side 28 of the upper housing member 22. The flat handrest system 10 can also be set up such that the belt 24 travels under edge portions 30 of the upper housing member 22 that define the opening 26 therein of the top side 28 of the upper housing member 22.

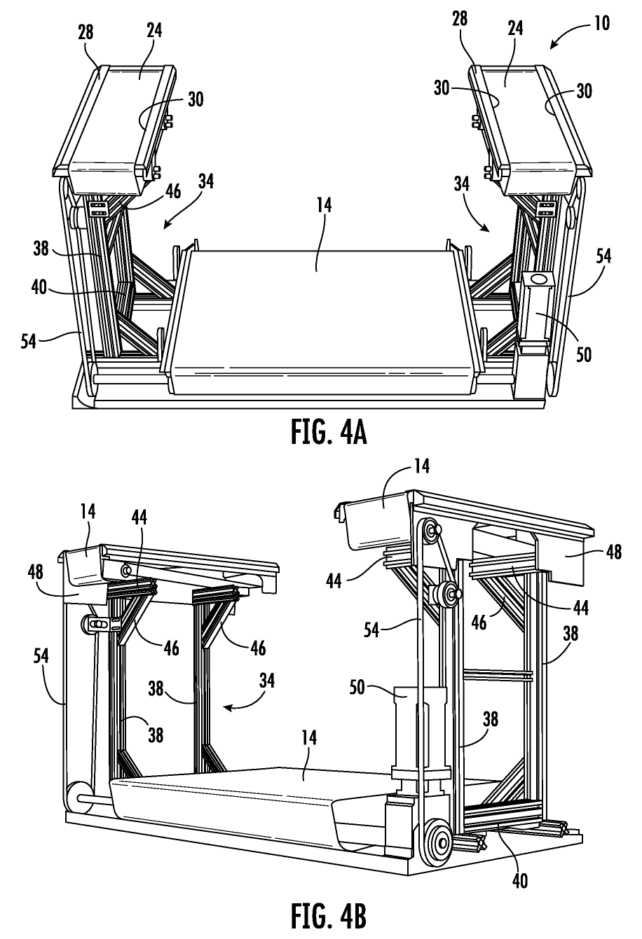

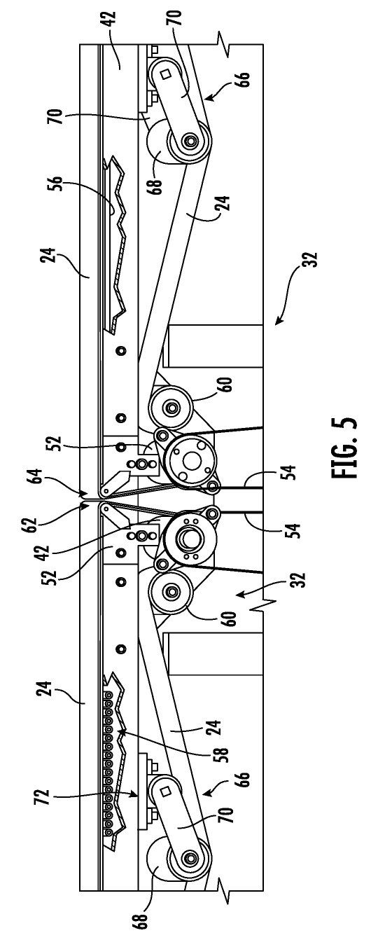

Referring now to FIGS. 4A-5, the flat handrest system 10 includes the belt 24, a propulsion system 32 for driving the belt 24 and a support structure 34 for supporting the components of the flat handrest system 10. The belt 24 can be any type of material such that it can be driven around a loop that includes being driven along, through, above or below the opening 26 in the top side 28 of the upper housing member 22 of the side housing 16. The support structure 34 can include frame members for supporting the belt 24 of the flat handrest system 10 at a desired height. The frame members can be made up of vertical members 38 that extend up from base members 40 to outer lateral support members 42 that are positioned on an outer side of the belt 24. The outer lateral support members 42 extend from the vertical members 38 primarily to support various parts of the propulsion system 32. The support structure 34 can include various other support members to support various parts of the flat handrest system 10. For example, the support structure 34 can also include lateral frame members 44 that can extend from the vertical members 38 in a direction generally perpendicular to the direction the belt 24 travels and angled support members 46 that extend from the lateral frame members 44 back to the vertical members 38. The support structure 34 can also include inner lateral support members 48 on the inner side of the belt 24 to further support various parts of the propulsion system 32. The outer lateral support members 42 and the inner lateral support members 48 could also be attached to the upper housing member 22 of the side housing 16. The outer lateral support members 42 and the inner lateral support members 48 could also be attached to the outer member 20 and inner member 18 of the side housing 16, respectively.

The propulsion system 32 includes a motor 50 for driving the belt 24 around the loop and a drive roller 52 for transferring the motor power to the belt 24. The belts 24 can be driven at a speed that is the same or substantially the same as the treadway 14 for the moving walkway 12. The motor 50 could be dedicated for use with only the flat handrest system 10, or the motor 50 that powers the flat handrest system 10 could also be the motor 50 that drives the treadway 14 of the moving walkway 12. A single motor 50 could also be used to drive belts 24 for multiple handrest systems 10. The motor 50 could be directly connected to the drive roller 52, or the motor 50 could transfer rotational force to the drive roller 52 via a drive belt 54, or some other mechanism known in the art capable of applying rotational force to the drive roller 52. In certain embodiments, each flat handrest system 10 could include multiple motors 50 and multiple drive rollers 52. The propulsion system 32 can also include a slide plate 56 mounted under the part of the belt 24 that makes up the upper part of the belt loop to provide stability to the belt 24 when a passenger applies weight to the belt (i.e., a portion of a passenger’s body weight or the weight of an object). The slide plate 56 can be positioned under as little or as much of the upper part of the belt loop as desired. In another embodiment, the propulsion system 32 could include a roller bed 58 instead of the slide plate 56 to facilitate support of the top part of the belt 24.

The flat handrest system 10 can include any number of rollers 60 to frame the path of the belt 24. The rollers 50 can be supported by any components of the support structure 34, brackets, etc. The flat handrest system 10 can include a first edge roller 62 and a second edge roller 64 to define the upper edges of the belt loop. The edge rollers 62 and 64 can have any desired diameter/radius such that the space between adjacent belts 24 of adjacent walkway modules 12a is sufficient to provide a better transition between adjacent moving walkway modules 12a. In one embodiment, the edge rollers 62 and 64 can have a diameter less than about 70mm. In another embodiment, the edge rollers 62 and 64 can have a diameter less than about 50mm. In a further embodiment, the edge rollers 62 and 64 can have a diameter less than about 35mm. In yet another embodiment, the edge rollers 62 and 64 can have a diameter less than about 20mm. In other embodiments, the edge rollers 62 and 64 can have a diameter less than about 16 mm, 12mm, or 8 mm.

The flat handrest system 10 can also include a tension apparatus 66 that can be implemented to provide the desired amount of tension to the belt 24. The tension apparatus 66 can be installed such that it interacts with the belt 24 on the lower part of the belt loop. In one embodiment, the tension apparatus 24 can include a tension roller 68 that contacts the belt 24, arms 70 positioned on each side of the tension roller 68 that extend to a tensioning mechanism 72 that can force the tension roller68 toward or away from a part of the belt 24 in the belt loop. The tensioning mechanism 72 can be any device known in the art capable of acting on the arms 70 to move the tension roller 68. For example, the tension can be applied manually via a CAM, threaded bolt mechanism, or other mechanism, or automatically via an actuator such as a servo motor, electric actuator, solenoid, and the like.

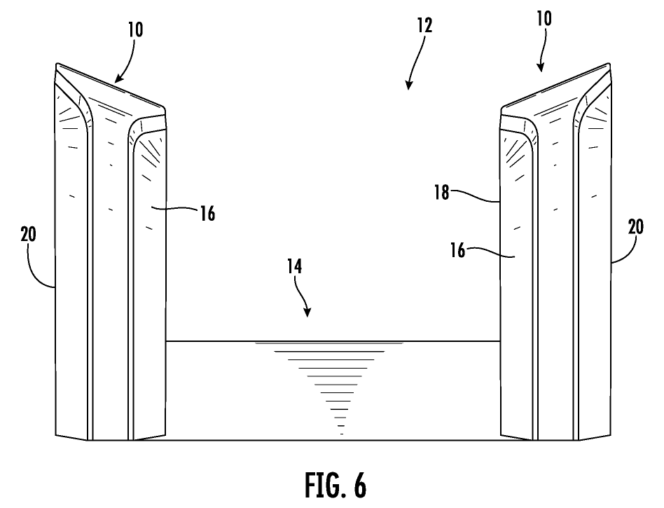

Each flat handrest system 10 can be set up to have the desired ergonomic layout. For example, each flat handrest system 10 can be set up such that the top part of the belt 24 in the upper side of the belt loop can be level, or runs parallel to the treadway 14 of the moving walkway 12. In another embodiment shown in FIG. 6, each flat handrest system 10 can be canted (i.e., sloped, slanted, etc.) toward the center of the treadway 14. In other words, the inner side of the belt 24 of the flat handrest system 10 is lower than the outer side of the belt 24. The degree of the angle the belt 24 of the flat handrest system 10 (and the appropriate supporting parts) is canted can vary. In one embodiment, the belt 24 of the flat handrest system 10 can be canted about 45 degrees or less from level (or relative to the treadway 14 of the moving walkway 12). In another embodiment, the belt 24 of the flat handrest system 10 can be canted about 35 degrees or less from level. In yet another embodiment, the belt 14 of the flat handrest system 10 can be canted about 20 degrees or less from level. In a further embodiment, the belt 24 of the flat handrest system 10 can be canted about 10 degrees or less from level. In an even further embodiment, the belt 24 of the flat handrest system 10 can be canted about 5 degrees or less from level.

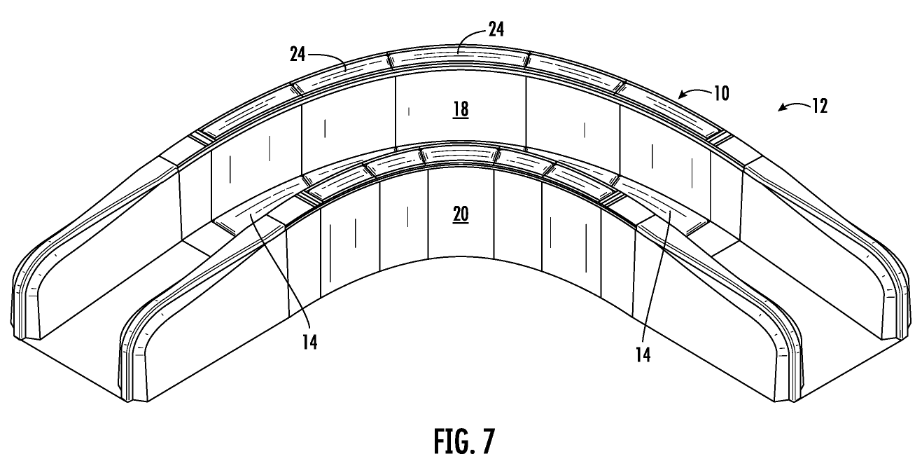

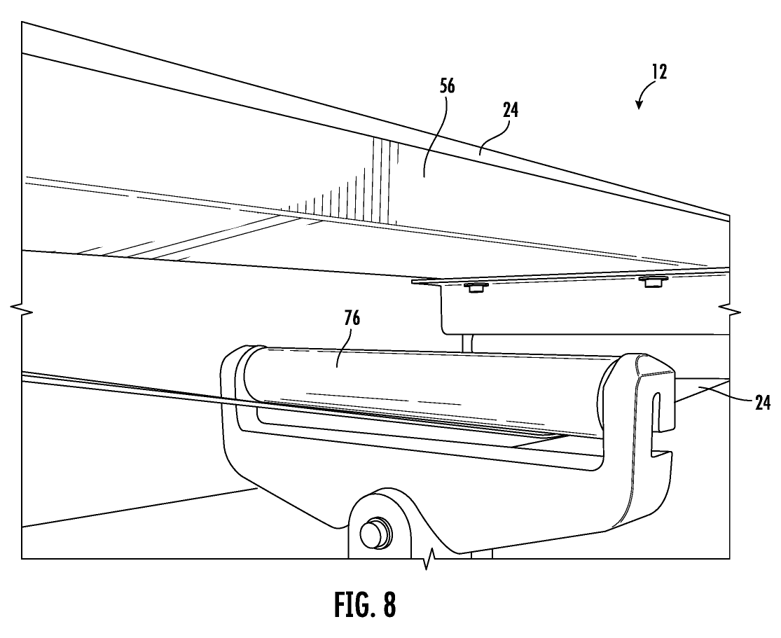

The flat handrest system 10 can be implemented with moving walkways 12 that are linear and move only in a straight line. As shown in FIG. 7, the flat handrest system 10 can also be designed to be curved and be implemented with a moving walkway 12 that includes curves and bends in its layout. The flat handrest system 10 can include sensors (not shown) to monitor the belt to determine its lateral position. The flat handrest system 10 can be set up such that if the lateral position of the belt 24 gets too far offline, the belt 24 can be shut down. The flat handrest system 10 could also include an alignment mechanism for moving the best 24 back in line if the belt 24 gets mistracked. In one embodiment shown in FIG. 8, the flat handrest system can include a pivoting roller 76 that can be manipulated to move the belt 24 back in line if the sensors determine the belt to be a certain distance offline. In another embodiment, the flat handrest system 10 could include a roller that is part of a hammock-like mechanism that would recenter the belt 24 in the event that the belt 24 mistracked.

The motors 50 used to drive the belts 24 of the flat handrest system 10 can include encoders to ensure the belts 24 are operating at the proper speed. Additional encoders may be added to monitor the speed of each belt 24 to provide redundancy.

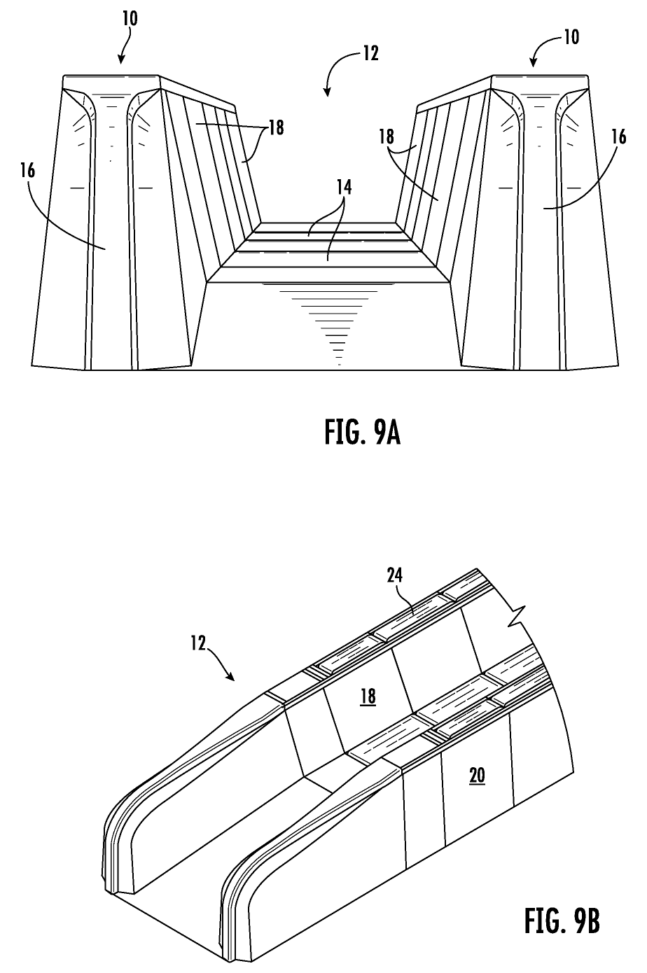

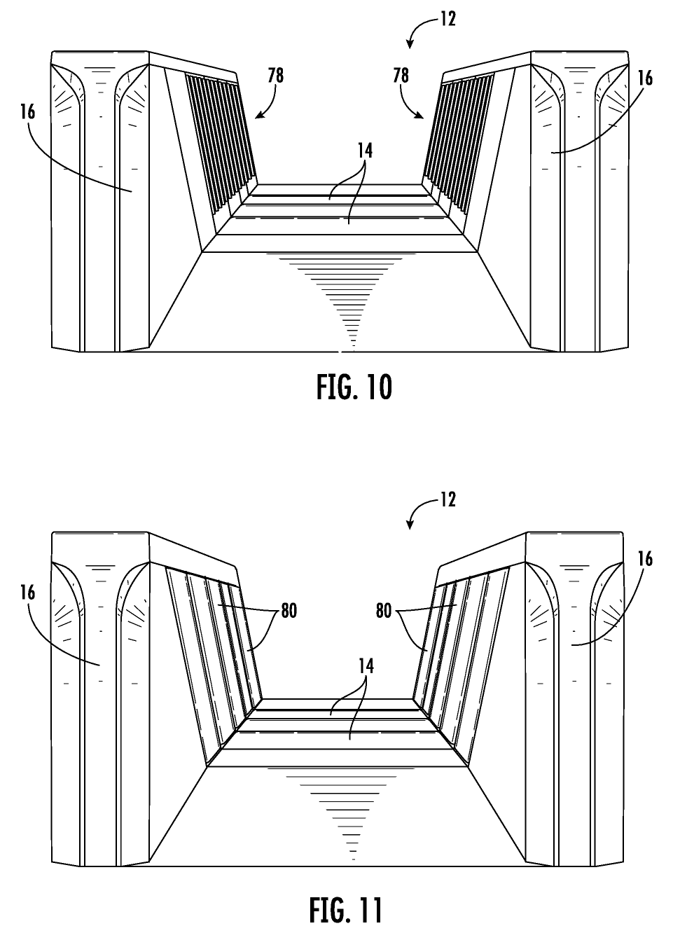

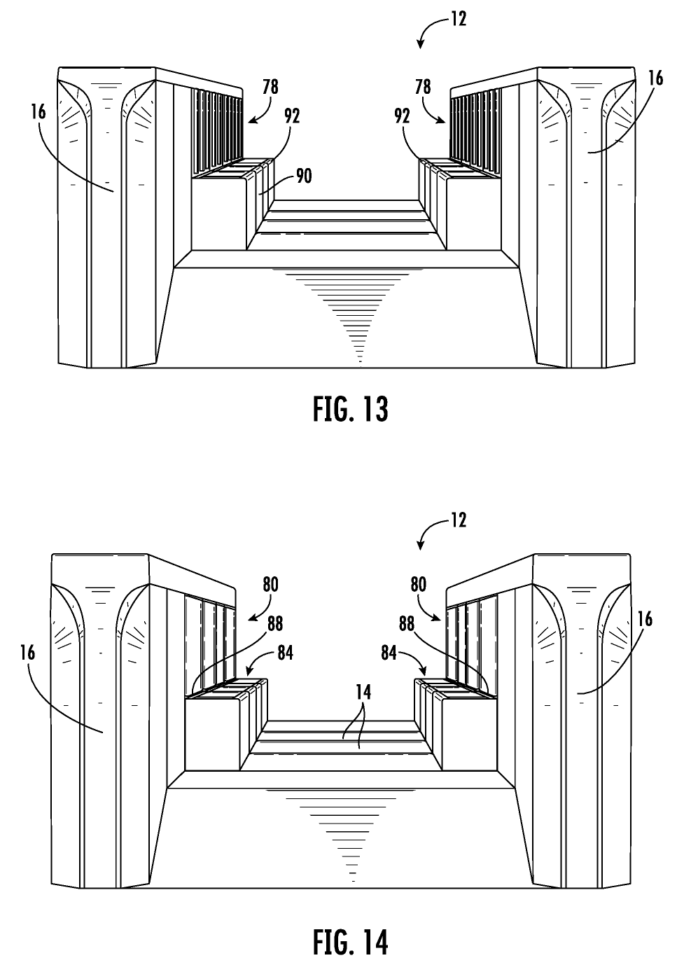

The present disclosure is also directed to uniquely designed moving walkways 12 shown in FIGS. 9A-14. In one embodiment shown in FIGS. 9A and 9B, the inner housing members 18a and 18b of the two side housings 16a and 16b can be angled sidewalls such that the distance between the inner housing members 18a and 18b decreases as they extend from the upper housing members 22a and 22b to the moving treadway 14. The moving walkway 12 shown in FIGS. 9A and 9B can include flat handrest systems 10 in the upper housing members 22a and 22b that can either be flat or canted as described herein, or the side housings 16a and 16b can be static and not include a flat handrests system 10. The angled sidewalls can be static, constructed of low friction plates or include some movement facilitating component built therein. The movement facilitating component can be non-motorized or motorized roller beds 78 (see FIG. 10) or the movement facilitating component could be a moving belt system 80 (see FIG. 11). The roller bets 78 can be supported by any and all components known in the art for use with traditional roller beds that are horizontally oriented. The moving belt systems 80 used in the angled sidewalls of these unique moving walkways 12 can be essentially the same system as the flat handrest system 10 described herein. The moving belt systems 80 are disposed at a non-horizontal angle. The side housings 16 and thus, the inner housing members 18 are not limited to any height. For example, they could be tall enough such that person riding the moving walkway 12 could lean against the inner housing members 18 while being transported by the moving walkway 12.

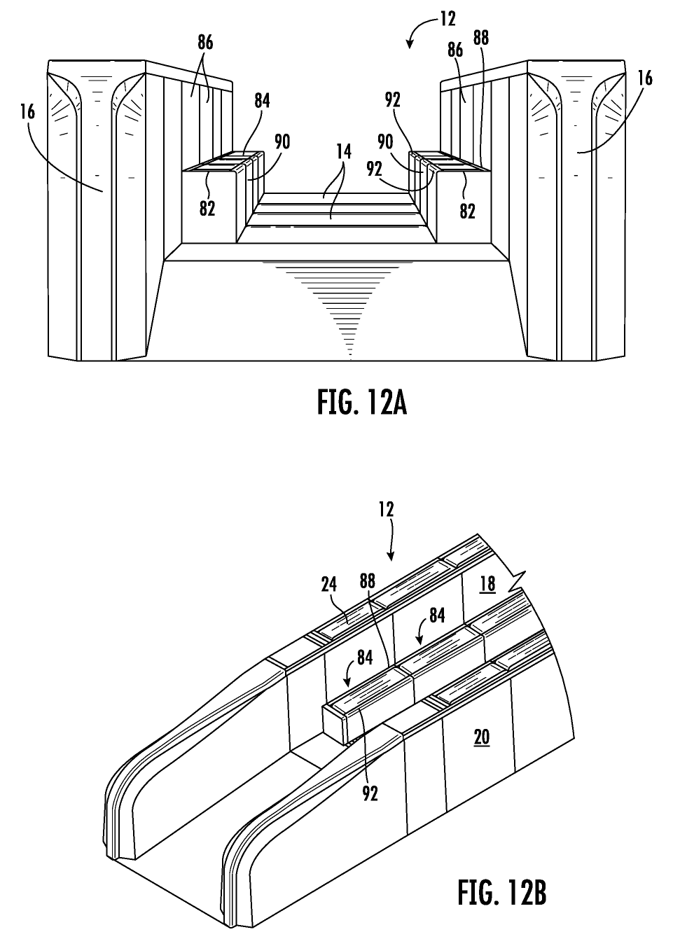

Referring now to FIGS. 12A-14, the inner housing member 18a and/or 18b can include a lateral section 82 with a seated moving system 84 disposed therein. The seated moving system 84 provides passengers with a place to sit down and move along the moving walkway 12 while seated. The seated belt system 84 can have essentially the same operational components as the flat handrest system 10 disclosed herein. In this embodiment, the lateral sections 82 split the inner housing members 22a and 22b into an upper sections 86a and 86b that extend upward from back sides 88a and 88b of the lateral sections 82a and 82b, respectively, and lower sections 90a and 90b that extend downward from front sides 92a and 92b of the lateral sections 82a and 82b, respectively. Similar to the angled sidewalls described herein, the upper sections 86a and 86b and the lower sections 90a and 90b can be static, constructed of low friction plates or include some movement facilitating component built therein. The movement facilitating component can be the same as that described above. The upper sections 86a and 86b can extend directly upward or they can be angled. While a seated moving system 84 is shown on both sides of the moving walkway 14, it should be understood and appreciated that only one side of the moving walkway could have a seated moving system 84 and the other side of the moving walkway 14 could be setup as any other embodiment described herein.

From the above description, it is clear that the present disclosure is well-adapted to carry out the objectives and to attain the advantages mentioned herein as well as those inherent in the disclosure. While presently preferred embodiments have been described herein, it will be understood that numerous changes may be made which will readily suggest themselves to those skilled in the art and which are accomplished within the spirit of the disclosure and claims.

What is claimed is:

1. A flat handrest system, the flat handrest system comprising:
a belt engageable by passengers using a conveyance system;
a propulsion system for propelling the belt around a belt loop; and
wherein the flat handrest system is positioned within an opening of a side housing of a conveyance system, the opening defines an area where the belt can be engaged by the passengers.

2. The flat handrest system of claim 1 wherein an engagement surface of the belt is disposed below a top portion of the side housing when the belt is engageable by the passengers.

3. The flat handrest system of claim 1 wherein sides of the belt extend under an upper housing portion of the side housing.

4. The flat handrest system of claim 1 further comprising a first edge roller and a second edge roller to define ends of the belt loop.

5. The flat handrest system of claim 4 wherein the first and second edge rollers have diameters less than about 70mm.

6. The flat handrest system of claim 1 wherein the belt is curved to fit a conveyance system that is curved.

7. The flat handrest system of claim 1 wherein the flat handrest system is canted such that an engagement portion of the belt is angled relative to level.

8. The flat handrest system of claim 1 further comprising a slide plate or a bed of rollers positioned under the belt.

9. A conveyance system, the conveyance system comprising:
a moving treadway;
at least one side housing disposed adjacent to the moving treadway; and
a flat handrest system positioned adjacent to an upper portion of the side housing; and
an opening disposed in the side housing to define an area where the belt can be engaged by passengers, the flat handrest system comprising:
a belt engageable by passengers using the conveyance system; and
a propulsion system for propelling the belt around a belt loop.

10. The conveyance system of claim 9 comprising a side housing disposed on each side of the moving treadway wherein the distance between inner housing members of each side housing decreases along at least a portion of the side housing from the upper housing portion to the moving treadway.

11. The conveyance system of claim 10 wherein the inner housing members include a plurality of rollers to facilitate movement of passengers down the conveyance system.

12. The conveyance system of claim 10 wherein the inner housing members include a moving belt system disposed therein to facilitate movement of passengers down the conveyance system.

13. The conveyance system of claim 9 wherein side housing includes an inner housing member with a lateral section disposed therein.

14. The conveyance system of claim 13 wherein the lateral section can include a seated belt system disposed therein to permit passengers to sit and be transported down conveyance system.

15. The conveyance system of claim 14 wherein the conveyance system has two side housings and at least one of the side housings includes a lateral section with a seated belt system disposed therein.

16. The conveyance system of claim 14 wherein the inner housing member further includes an upper section extending upward from a rear portion of the lateral section and a lower section extending downward from a front portion of the lateral section.

17. The conveyance system of claim 16 wherein the upper section of inner housing member includes a plurality of rollers to facilitate movement of passengers down the conveyance system.

18. The conveyance system of claim 16 wherein the upper section of the inner housing member includes a moving belt system disposed therein to facilitate movement of passengers down the conveyance system.

19. The conveyance system of claim 9 wherein an engagement surface of the belt is disposed below the upper portion of the side housing when the belt is engageable by the passengers.

20. A flat handrest system, the flat handrest system comprising:
a belt engageable by passengers using a conveyance system;
a propulsion system for propelling the belt around a belt loop; and
wherein the belt of the flat handrest system is non-graspable by the passengers.
